(19) United States
(12) Patent Application Publication
(10) Pub. No.: US 2026/0227338 A1
(43) Pub. Date: Aug. 6, 2026

(54) DETECTING DEFECTS IN WIND TURBINE BLADES

(71) Applicant: LM Wind Power A/S, Kolding (DK)

(72) Inventors: Vamshi Kommareddy, New Delhi (IN); Younkoo Jeong, Schenectady, NY (US); Biswajit Medhi, New Delhi (IN); Prasad Thapa, New Delhi (IN); Valerio Crovasce, Schenectady, NY (US); Nagithimmaiah Kullegowdanapalya Lingapa, Cherbourg-en-Cotentin (FR)

(21) Appl. No.: 19/152,603

(22) PCT Filed: Feb. 1, 2024
(86) PCT No.: PCT/EP2024/052503

§ 371 Date: Jul. 31, 2025

(30) Foreign Application Priority Data
Feb. 2, 2023 (EP) 23154791.0

(51) Int. Cl. G01N 21/88; G01N 21/95

(52) U.S. Cl. CPC G01N 21/8806; G01N 21/95; G01N 2201/10

(57) ABSTRACT

In a first aspect, a wind turbine blade inspection system for detecting defects in a wind turbine blade is provided. The wind turbine blade inspection system comprises a directional light source, a diffuse light source, an image-capturing device and a controller. The controller is configured to analyze images from the image-capturing devices to detect a defect. In a further aspect, a computer-implemented method for detecting defects in a wind turbine blade is provided. In a yet further aspect, a computing system comprising a processor configured to perform a method according to any of the examples herein is provided. In yet a further aspect, a computing program comprising instructions, which, when the program is executed by a processor, cause the processor to carry out a method according to any of the examples herein is provided.

The present disclosure relates to wind turbine blade inspection systems, methods, controllers, and computing programs for detecting defects in wind turbine blades.

### BACKGROUND

Modern wind turbines are commonly used to supply electricity to the electrical grid. Wind turbines of this kind generally comprise a rotor with a rotor hub and a plurality of wind turbine blades. The rotor is set into rotation under the influence of the wind on the blades. The rotation of the rotor shaft drives the generator rotor either directly (“directly driven”) or through the use of a gearbox. The gearbox (if present), the generator, and other systems are usually mounted in a nacelle on top of a wind turbine tower.

Wind turbine blades are generally made from fiber-reinforced polymers or plastics (FRP's), which are composite materials consisting of a polymer matrix and reinforced with fibers. The fibers are usually glass or carbon and provide longitudinal stiffness and strength.

Wind turbine blades are commonly manufactured by joining two blade shell parts made from fiber-reinforced polymers, e.g. glass or carbon fiber reinforced polymers. These two blade shell parts are first molded and then joined together, e.g. through an adhesive. For example, a pressure side blade shell may be bonded to a suction side blade shell through joining lines along the leading edge and the trailing edge.

These blade shell parts may be molded using a resin infusion technology or a prepreg technology. In resin infusion technology, fibers are placed in a mold and then, the resin is injected into the mold cavity under pressure. This resin fills the volume between the cavity, and then, the resin is cured or hardened. Examples of resin infusion technology may be Resin Transfer Molding (RTM) or Vacuum Assisted Resin Transfer Molding (VARTM). In VARTM, the resin is injected under a vacuum or pressure lower than atmospheric.

Since blade manufacturing is a complex task, defects may occur during blade manufacturing. A defect is a flaw or weakness in a blade that can trigger a failure of the wind turbine blade in operation. Different types of defects may occur during blade manufacturing. For example, fibers can be misaligned in the mold before or during curing. These fiber misalignments may lead to wrinkles or steps on the blade shell which may reduce the compressive strength of the composites.

Layers of fibers can also be debonded or delaminated, i.e. fiber layers may get separated due to a lack of fusion between layers. These debond or delamination defects may serve as initiation points for crack growth. Voids and air bubbles may also occur during blade manufacturing when air pockets are trapped in the materials of the blade shell. During the operation of the wind turbine blade, these voids and air bubbles may create a local stress concentration. Foreign materials may also be trapped in the composite material. Other examples of defects may be dry areas when some areas of the blade shell lack resin.

Wind turbine blades may be manually inspected to detect manufacturing defects. Qualified operators are employed to visually inspect wind turbine blades, e.g. blade shell parts. For example, operators may visually inspect the blade shell parts when placed in the mold. This inspection generally requires a considerable amount of time. Furthermore, this human inspection relies on the subjectivity and expertise of the operators. In addition, training the operators to detect manufacturing defects is also time-consuming.

The present disclosure provides examples of systems and methods that at least partially resolve some of the aforementioned disadvantages.

### SUMMARY

In a first aspect, a wind turbine blade inspection system for detecting defects in a wind turbine blade is provided.

The wind turbine blade inspection system comprises a directional light source to illuminate an inspection surface of a wind turbine blade at an acute angle relative to the inspection surface and a diffuse light source to diffusely illuminate the inspection surface of the wind turbine blade. In addition, the wind turbine blade inspection system comprises an image-capturing device to capture an image of the inspection surface. The wind turbine blade inspection system further comprises a controller to selectively activate the directional light source or the diffuse light source, receive from the image-capturing device an image of the inspection surface when illuminated by the directional light source and when illuminated by the diffuse light source, and analyze the received images of the inspection surface to detect a defect.

In this disclosure, a directional light source shall be understood as a light source that emits light and projects this light at an acute angle relative to the inspection surface. The directional light source is thus configured to emit a light beam to directly illuminate the inspection surface at an acute angle.

Light beam is light which propagates from a light source essentially in one direction. A light beam angle is an angular expression that shows how light is emitted from a light source and can be defined as the degree of width that light emits from a light source. As the light spreads, the intensity decreases. Smaller light beam angles thus provide a concentrated light. The light beam angle is the angle between opposed points on the light beam axis where the intensity drops to 50% of its maximum value. In the context of this disclosure, the light beam angle of a directional light source ranges greater than 0° and lower than 90°, specifically greater than 0° and lower than 45°, and more specifically greater than 0° and lower than 30°. These light beam angles provide that the directional light source emits light in a concentrated manner.

A directional light source illuminating an inspection surface shall be understood as a directional light source emitting light at an angle towards the inspection surface. In the context of this disclosure, the light beam axis emitted by the directional or offset light source forms an acute angle relative to the inspection surface, i.e. the angle of incidence to the inspection surface is acute. The acute angle formed by the light beam axis and the inspection surface is below 70°, e.g. between 10° and 70°. The light beam may thus illuminate the inspection surface at the acute angle, corresponding to the angle formed between the light beam axis (which is incident on the inspection surface) and the inspection surface. Due to the acute angle between the light beam axis and the inspection surface, the light beam angle of less than 90°, e.g. greater than 0° and lower than 45°, the directional light causes visible shadows, since the object is only lit from one direction at a specific angle and shaded from another.

In this disclosure, the angle formed between the directional light and the inspection surface refers to the angle of the light beam axis relative to the inspection surface.

In this disclosure, a diffuse light source shall be understood as a light source that emits light in all directions. Contrary to directional light sources, light emitted from a diffused light source is not concentrated in a specific area. Diffused light may thus be regarded as indirect light. Light emitted from a diffused light source is spread evenly across the surface normal to the diffused light source.

The light emitted from the directional light source is thus substantially concentrated, i.e. the light beam angle is greater than 0° but lower than 90°, specifically greater than 0° but lower than 45°, and more specifically greater than 0° but lower than 30 °. In contrast, the diffuse light source propagates in all directions, i.e. the diffuse light source is spread evenly across the inspection surface. The light beam angle of diffused light is thus greater than the light beam angle of directional light.

According to this aspect, defects in the wind turbine blade can be automatically detected. The inspection time and the number of operators required for inspecting the wind turbine blade may thus be reduced. Furthermore, the accuracy and consistency of the inspection are increased. The quality of the wind turbine blade is thus improved, while the number of false defects is reduced.

Furthermore, using two different types of light sources to light the same surface improves the detection capacity of the system. Depending on the morphology of the wind turbine blade defect, the accuracy of the detection may be improved by illuminating the inspection surface with one of the light sources. The reliability of defect detection may thus be improved.

Some types of defects, such as wrinkles or steps may be more easily detected by the image-capturing device when illuminated by a directional light source, i.e. with a concentrated light beam. The directional light emitted by the directional light source creates shadows when a wrinkle or step is illuminated. This shadow may be easily captured by the image-capturing device. However, wrinkles or step defects are not easily visible when illuminated with a diffused light since no identifiable shadows are created unless the wrinkle or step defects are substantially large.

Other types of defects, such as delamination, voids, and air bubbles may be easily detected when illuminated with diffused light. These defects may scatter the light projected by the diffused light source to improve the identification of these types of defects.

Accordingly, the present disclosure aims at improving the recognition and detection of different types of defects in wind turbine blades by using two different types of lights.

In a further aspect, a computer-implemented method for detecting defects in a wind turbine blade is provided. The computer-implemented method comprises activating a directional light source of a wind turbine blade inspection system to illuminate an inspection surface of a wind turbine blade at an acute angle relative to the inspection surface, and receiving, by a controller, a first image of the inspection surface illuminated by the directional light source. Furthermore, the computer-implemented method comprises activating a diffuse light source of the wind turbine blade inspection system to diffusely illuminate the inspection surface, and receiving, by the controller, a second image of the inspection surface illuminated by the diffuse light source. The computer-implemented method further comprises analyzing, by the controller, the first and the second images of the inspection surface to detect a defect in the inspection surface.

In a yet further aspect, a controller or computing system comprising a processor configured to perform a method according to any of the examples herein is provided.

In yet a further aspect, a computing program comprising instructions, which, when the program is executed by a processor, cause the processor to carry out a method according to any of the examples herein is provided.

Advantages derived from these aspects may be similar to those mentioned regarding the first aspect.

### BRIEF DESCRIPTION OF THE DRAWINGS

Non-limiting examples of the present disclosure will be described in the following, with reference to the appended drawings, in which:

FIG. 1 illustrates a perspective view of a wind turbine according to one example;

FIG. 2 shows a perspective view of a wind turbine blade according to one example;

FIG. 3 shows a cross-sectional view of the wind turbine blade of FIG. 2;

FIG. 4a schematically represents a directional light source illuminating a defect in an inspection surface according to an example;

FIGS. 4b and 4c schematically represent examples of a diffuse light source illuminating a defect in an inspection surface;

FIG. 5a schematically represents a wind turbine blade inspection system for detecting defects in a wind turbine blade when a directional light source is illuminating an inspection surface according to an example of the present disclosure;

FIG. 5b schematically represents the wind turbine blade inspection system of FIG. 5a when a diffused light source is illuminating the inspection surface;

FIGS. 6a and 6b respectively illustrate a frontal and a side view of a wind turbine blade inspection system according to an example of the present disclosure;

FIG. 7 schematically represents a wind turbine blade inspection system according to an example of the present disclosure;

FIG. 8 schematically represents a wind turbine blade inspection system according to an example of the present disclosure;

FIG. 9 is a block diagram of a computer-implemented method for detecting defects in a wind turbine blade according to an example of the present disclosure;

FIGS. 10A, 10B and 10C are respectively block diagrams of a computer-implemented method for detecting defects in a wind turbine blade shell according to an example of the present disclosure; and

FIG. 11 represents a controller and a computing program according to an example of the present disclosure.

### DETAILED DESCRIPTION OF EXAMPLES

In these Figures, the same reference signs have been used to designate matching elements.

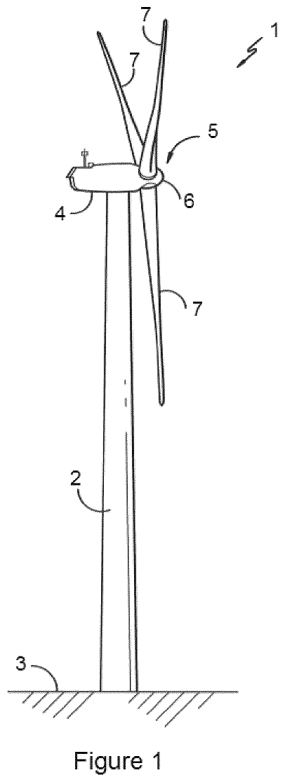

FIG. 1 illustrates a perspective view of one example of a wind turbine 1. As shown, the wind turbine 1 includes a tower 2 extending from a support surface 3, a nacelle 4 mounted on the tower 2, and a rotor 5 coupled to the nacelle 4. The rotor 5 includes a rotatable hub 6 and at least one wind turbine blade 7 coupled to and extending outwardly from the rotor hub 6. For example, in the illustrated example, the rotor 5 includes three wind turbine blades 7. However, in an alternative embodiment, the rotor 5 may include more or less than three blades 7. Each wind turbine blade 7 may be spaced from the rotor hub 6 to facilitate rotating the rotor 5 to enable kinetic energy to be transferred from the wind into usable mechanical energy, and subsequently, electrical energy. For instance, the rotor hub 6 may be rotatably coupled to an electric generator positioned within the nacelle 4 or forming part of the nacelle to permit electrical energy to be produced.

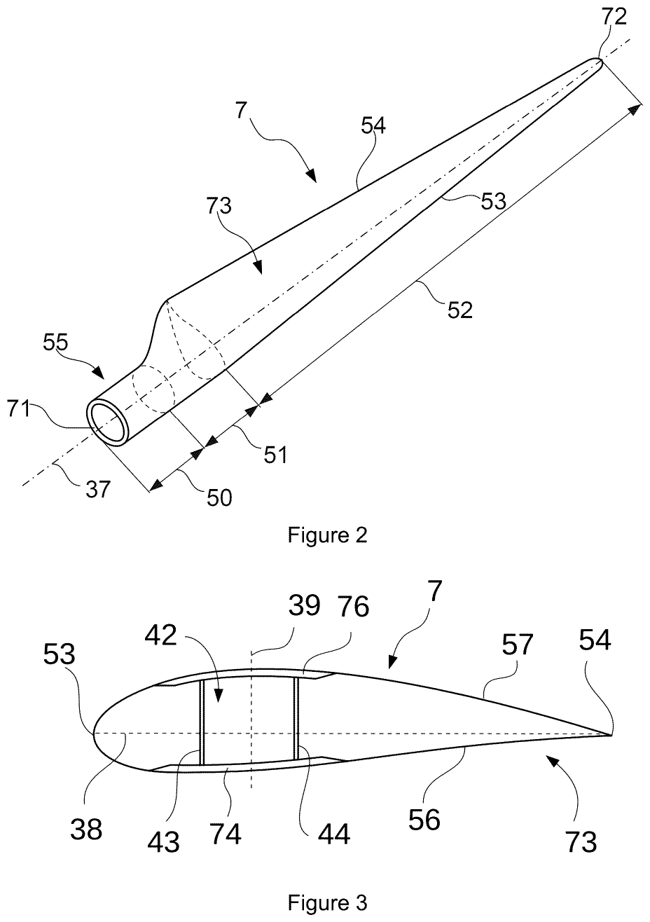

FIG. 2 illustrates an example of a wind turbine blade 7. The wind turbine blade 7 extends in a longitudinal direction or spanwise direction 37 from a blade root end 71 to a blade tip end 72. The blade 7 comprises a blade root region or portion 50 closest to the rotor hub, a profiled or an airfoil portion 52 furthest away from the rotor hub and a transition portion 51 between the blade root portion 50 and the airfoil portion 52. The blade 7 comprises a leading edge 53 facing the direction of rotation of the blade 7 when mounted on the rotor hub, and a trailing edge 54 facing the opposite direction of the leading edge 53.

The airfoil portion 52 has a shape designed to generate lift, whereas the blade root portion 50 has a circular or elliptical cross-section for structural considerations and easy mounting of the blade to the rotor hub. The diameter or the chord of the blade root portion 50 may be constant along the entire blade root portion 50. At the transition portion 51, the profile gradually changes from the circular or elliptical cross-section of the blade root portion 50 to the airfoil profile of the airfoil portion 52. The wind turbine blade 7 may be connected to the rotor hub through a blade root attachment portion 55.

The wind turbine blade 7 comprises a blade shell 73. The blade shell 73 comprises an outer side or surface that defines the external shape of the blade, e.g. the outer shape at the blade root portion and the outer shape at the airfoil portion. The blade shell 73 also comprises an inner side or surface that defines the internal volume of the blade and faces a load-carrying structure (not shown). The blade shell 73 may be made of fiber-reinforced polymer or plastics, e.g. glass fiber and/or carbon fiber.

The blade shell may be formed by a plurality of blade shell parts. The plurality of blade shell parts may be joined together to form the blade shell. The blade shell parts may be formed and then joined according to any of the examples herein disclosed. Resin infusion technology, e.g. RTM or VARTM, or prepreg technology may be used for manufacturing the blade shell parts.

In some examples, the blade shell comprises a pressure side blade shell part and a suction side blade shell part. The pressure side blade shell part may be joined to the suction side blade shell part along joining lines along the leading edge 53 and the trailing edge 54. Each of these blade shell parts may be manufactured in a mold and then joined together to define the entire blade shell of the wind turbine blade 7. A load-carrying structure may be arranged between the pressure side blade shell part and the suction side blade shell part.

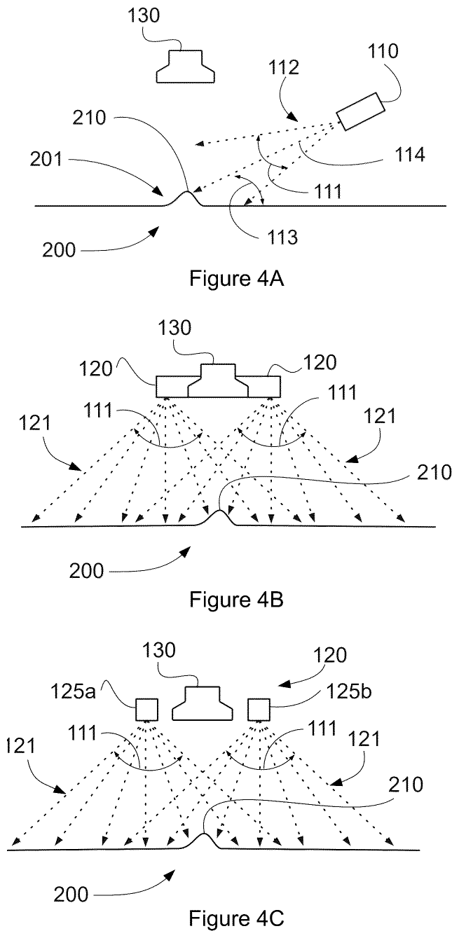

FIG. 3 shows a cross-sectional view of the wind turbine blade of FIG. 2. A suction side 57 or downwind side, and a pressure side 56 or upwind side extend from the leading edge 53 to the trailing edge 54. The wind turbine blade 7 further comprises a chord line 38 between the leading edge 53 and the trailing edge 54. The chord line 38 extends in an edgewise direction or chordwise direction. A flapwise direction 39 is substantially perpendicular to the chord line 38.

The wind turbine blade 7 comprises a blade structure that provides stiffness to the wind turbine blade. The blade structure of this example comprises the blade shell 73 and a load-carrying structure. In further examples, the blade structure may also comprise a plurality of structural ribs arranged along the length of the blade. In this example, the load-carrying structure comprises shear webs, such as a leading edge shear web 43 and a trailing edge shear web 44. A cavity 42 is defined between the leading edge shear web 43 and the trailing edge shear web 44. The cavity 42 may extend throughout a length along the spanwise direction. The load-carrying structure of this figure also comprises a pressure side spar cap 74 arranged at the pressure side 56 and a suction side spar cap 76 at the suction side 57. In some examples, the shear webs 43 and 44 could be a spar box with spar sides, such as a trailing edge spar side and a leading edge spar side.

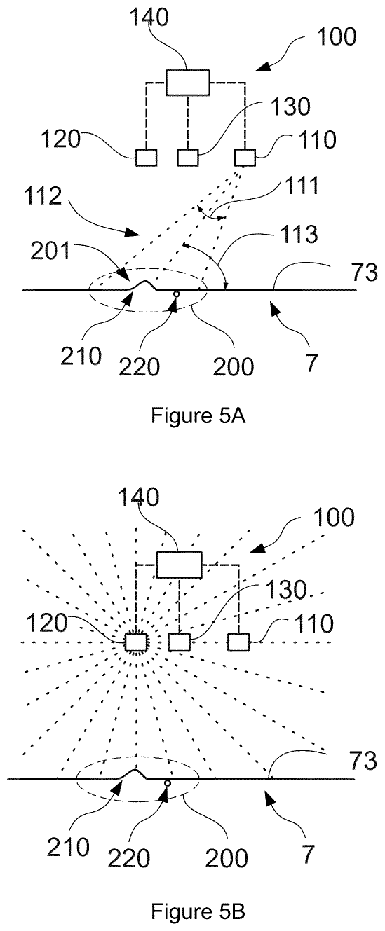

FIG. 4a schematically represents a directional light source 110 illuminating a defect in an inspection surface 200 according to an example. The defect of this figure is a wrinkle 210. The directional light source 110 emits a directional light 112 toward the inspection surface 200.

The light beam angle 111 may be greater than 0° but lower than 90°. The directional light 112 is thus relatively concentrated. In this example, the light beam angle 111 is about 20°. In some examples, the light beam angle 111 may be greater than 0° but lower than 30°.

The directional light 112 is emitted forming an acute angle 113 relative to the inspection surface 200. The angle 113 is measured between the inspection surface and the light beam axis 114. The light beam axis 114 is the axis of the cone defined by the directional light 112 emitted by the directional light source 110. The angle 113 is below 70° to form a shadow region 201 when illuminates the wrinkle 210 of the inspection surface 200. The shadow region 201 is formed at the opposite side of the directional light source 110 with respect to the wrinkle 210.

An image-capturing device 130 arranged above the inspection surface may thus acquire an image of the shadow region 201.

FIGS. 4b and 4c schematically represent examples of a diffuse light source illuminating a defect in an inspection surface.

In FIG. 4b, the diffuse light source 120 is arranged concentrically to the image-capturing device 130. In FIG. 4c, the diffuse light source 120 is arranged adjacent to the image-capturing device 130. The diffuse light source 120 of FIG. 4c comprises a pair of diffuse light source units 125a and 125b. These diffuse light source units 125a and 125b are arranged at opposite sides of the image-capturing device 130.

The diffuse light sources 120 of these figures emit diffuse light 121 in different directions. The light beam angle 111 of these figures is greater than 120°. In some examples, the light beam angle 111 may be greater than 180°. In some examples, the diffuse light sources 120 may emit light around 360°, i.e. in all directions. In these examples, the light beam angle 111 may be regarded to be 360°. The diffused light sources 120 are arranged perpendicular to the inspection surface 200.

As the diffused light 121 is emitted in different directions, shadows created by one ray or direction of the diffused light are cleared by other rays of the diffused light 121.

Accordingly, no clear shadows are formed on the inspection surface. Substantially uniform illumination of the inspection surface is thus obtained. Light beam angles generated by directional light sources are thus smaller than light beam angles generated by diffuse light sources. Light emitted by directional thus forms a concentrated light beam.

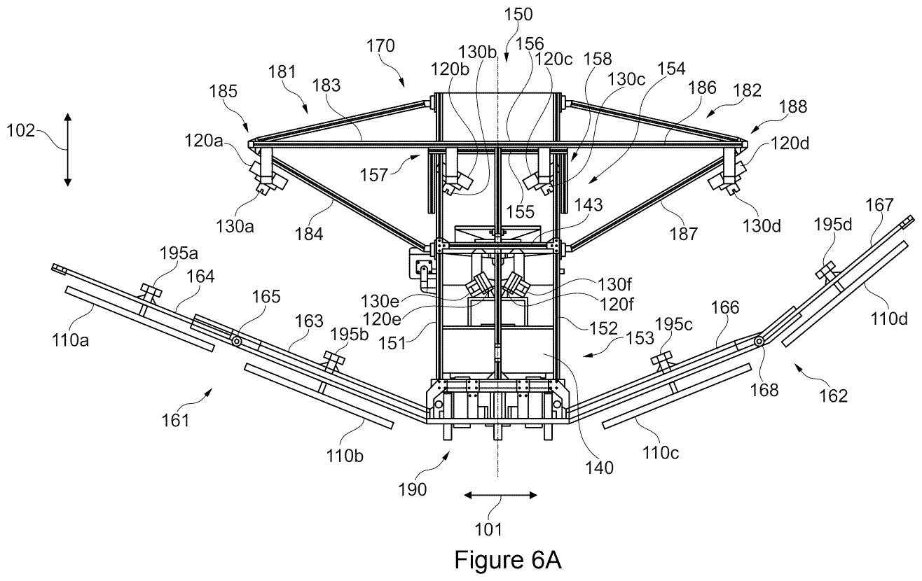

FIGS. 5a and 5b schematically represent a wind turbine blade inspection system 100 for detecting defects in a wind turbine blade according to an example. In FIG. 5a, a directional light source 110 directionally illuminates an inspection surface 200 of a wind turbine blade 7 and in FIG. 5b a diffuse light source 120 diffusively illuminates the inspection surface 200. In this example, the inspection surface 200 is a blade shell 73, in particular, an inner surface of the blade shell 73.

The inspection surface 200 of these figures comprises two different types of defects: a wrinkle 210 and an air bubble 220.

As can be seen in FIG. 5a, the directional light source 110 emits a directional light 112 toward the inspection surface 200. The directional light 112 comprises a light beam angle 111 of less than 90°. The angle 113 to the inspection surface from the centerline of the light source is up to 70 degrees.

Examples of directional light sources 110 may be LEDs (light-emitting diodes) and lasers. Some directional light sources may comprise a reflector to control or adjust the beam of light. When reflectors are used, additional light sources may be alternatively be used as directional light source, such as incandescent lamps or fluorescent lamps. Reflectors may concentrate a light beam of the incandescent lamp or a light beam of the fluorescent lamp. As a result, the light beam of the incandescent lamp or the light beam of the fluorescent lamp may be focused through reflectors such that the incandescent lamp or the fluorescent lamp directly illuminates the inspection surface. For example, incandescent lamps, fluorescent lamps, or LEDs may be provided with reflectors to limit the light up to a beam angle of 90 degrees, specifically up to a beam angle of 45°, and more specifically up to a beam angle of 30°. The reflector or lens arrangement may be provided around or in front of the light emitter to concentrate the light beam angle 111. The directional light sources 110 may emit directional light in any suitable wavelength.

The directional light 112 of FIG. 5a illuminates the wrinkle 210 and the air bubble 220 located within the inspection surface 200. The direct illumination of the wrinkle 210 with the directional light source 110 generates a shadow 201. However, no shadow is generated by illuminating the air bubble 220. It should be appreciated that other types of wind turbine defects, e.g. steps, can also produce shadows when illuminated by a directional light source 110.

The directional light source 110 directs the directional light 112 in an inclined manner. The axis of the light beam forms an acute angle 113 with the inspection surface, e.g. between 70° and 1°, specifically between 70° and 10°. Accordingly, the axis of the light beam is not perpendicular to the inspection surface. In this way, shadows formed by the defects may be more visible.

Contrary to the directional light 112 of FIG. 5a, FIG. 5b illustrates a diffuse light source 120 that emits a diffused light 121. The diffused light 121 of FIG. 4b is emitted in all directions. In this example, the diffuse light source 120 emits diffused light 121 at 360° degrees. In other examples, the diffused light 121 may be emitted with a light beam angle greater than 90°, e.g. greater than 180°.

As the diffused light 121 is not concentrated in a single direction, shadows formed by one ray are illuminated by other rays. Accordingly, no well-defined shadows can be formed. In this sense, no shadow is formed when illuminating the wrinkle 210 with the diffused light projected in multiple directions. The diffused light 121 is generally reflected by surfaces in a substantially uniform manner. However, the air pocket or air bubble 220 scatters the diffused light 121 projected onto the air bubble 220. Accordingly, the light reflected by the air bubble 220 is different from the light reflected by other parts of the surface of the inspection surface 200. Other types of defects, e.g. delamination, may also scatter the diffused light 121. Diffused light 121 may also be efficiently employed to identify these other types of defects. The diffused light source 120 may emit diffused light in any suitable wavelength.

An image-capturing device 130 is configured to capture an image of the inspection surface 200. In some examples, the image-capturing device 130 may comprise a digital camera, e.g. an optical digital camera, and/or a video camera. In some examples, the image-capturing device 130 may comprise an infrared camera. The image-capturing device 130 may capture light from any suitable wavelength. In some examples, the image-capturing device may capture wavelengths of visible light that fall between 400 nm and 700 nm. In some examples, the image-capturing device may capture the infrared spectrum from 700 nm to 1200 nm.

The image-capturing device 130 may acquire or capture an image of the inspection surface 200 when illuminated by the directional light 112, as depicted in FIG. 5a. The image-capturing device 130 may thus capture the shadow 201 generated by the directional light facing the wrinkle 210 in this first image.

The image-capturing device 130 may also capture an image of the inspection surface 200 when illuminated with the diffused light 121, as illustrated in FIG. 5b. As light reflected by the air bubble 220 is different from light reflected by the surrounding surface, the air bubble 220 can be identified in the second image captured by the image-capturing device 130.

The wind turbine blade inspection system 100 further comprises a controller 140. The controller 140 may control the operation of the wind turbine blade inspection system 100. The controller 140 of these figures is communicatively coupled to the directional light source 110, to the diffuse light source 120 and to the image-capturing device 130.

The controller 140 is configured to selectively activate the directional light source 110 or the diffuse light source 120 to illuminate the inspection surface 200 of wind turbine blade 7. The controller 140 is further configured to receive, from the image-capturing device 130, an image of the inspection surface 200 when illuminated by the directional light source 110 and when illuminated by the diffuse light source 120. The controller 140 may thus receive a first image (illuminated by a directional light) and a second image (illuminated by a diffuse light).

In some examples, the controller 140 may selectively instruct the image-capturing device 130 to capture an image of the inspection surface 200 when illuminated by the directional light source 110 and when illuminated by the diffuse light source 120. For example, the controller 140 may be configured to activate the directional light source 110 and to instruct the image-capturing device 130 to capture a first image while the inspection surface 200 is illuminated with the directional light 112. The controller 140 may further be configured to deactivate or turn off the directional light source 110 and activate or turn on the diffuse light source 120. The controller 140 may then instruct the image-capturing device to obtain a second image of the inspection surface 200 while it is illuminated with the diffused light 121.

The controller 140 is further configured to analyze the received images of the inspection surface to detect a defect. The analysis or processing of the images detects or identifies defects on the inspection surface 200.

In some examples, the controller 140 may compare the images from the image-capturing device 130 with a reference image. For example, the controller 140 may compare the received images with a reference image without defects. A difference between the received images and the reference image may indicate a defect in the inspection surface 200.

In some examples, the controller 140 may be configured to determine a type of defect if a defect in the inspection surface 200 is determined. For example, a defect identified in the image obtained with directional light 112 may be indicative of a wrinkle or step. On the other hand, when the controller 140 detects differences between the reference image and the image obtained with diffused light 121, this difference may indicate that the defect is at least one of a void, an air pocket, a debonded region, and/or delamination.

In some examples, a plurality of reference images may be stored in a reference image database. The controller 140 may compare the images of the inspection surface 200 with reference images of the reference image database. Identification of defects may thus be improved.

The reference images may comprise examples without defects, but also images with defects. The reference image database may thus comprise a plurality of images of different defects. For example, the reference image database may comprise a set of images having wrinkle defects, a set of images having step defects, a set of images having void defects, a set of images having air bubbling defects, and a set of images having delamination or debonding defects, and so on. Comparing the images captured from the image-capturing device 130 with the reference images describing different defects may improve the recognition of a specific defect. Accuracy in determining a type of defect may thus be enhanced.

The reference image database may be updated with images obtained during blade inspection. Furthermore, the reference image database may be manually updated or by using machine learning methods. The reference image database may further be updated with new wind turbine blade defects.

In some examples, analyzing the images may comprise classifying the images into images without defects and images with potential defects. The images with potential defects may then be further analyzed, e.g. compared with a plurality of reference images. Classifying images may thus reduce the data and time required for inspection purposes. Classifying images may employ statistical image processing and/or machine learning methods.

The controller 140 may be configured to use supervised models to analyze the images. Examples of supervised models may include a convolutional neural network (CNN), support vector networks machines (SVMs) and/or decision trees. For example, the controller 140 may be configured to use a convolutional neural network to analyze the images. Analyzing the images with a convolutional neural network may comprise classification, localization, and/or segmentation of images. In some examples, classification, localization, and segmentation may be sequential tasks. In some examples, at least two of these tasks may be performed together.

Using deep learning models to analyze the images may improve the accuracy and efficiency of the identification of blade defects. Determination of the type of blade defect may also be improved.

A deep learning algorithm may be used to train the convolutional neural network. A large amount of data may be considered to detect blade defects and/or their nature. The convolutional neural network may be trained with images of the inspection surface 200 comprising defects manually detected. The controller 140 may be configured to train the convolutional neural network with the images of the inspection surface received from the image-capturing device 130.

In some examples, the controller 140 performs a supervised training of a computer-implemented machine learning model, using a training data set comprising one or more images of the inspection surface 200 and a label indicating the presence or absence of a defect in each of the images. The supervised training may further comprise, for each image, setting an output parameter of the machine learning model corresponding to the label indicating the presence or absence of a defect.

In some examples, the controller 140 is configured to classify the images using a trained convolutional neural network. The controller 140 may thus be configured to detect, using a trained convolutional neural network, defects in an image. The output of classification may be either an image containing a defect, or an image without a defect.

In some examples, the controller 140 is configured to localize or determine the position of the defect within the image, e.g. by using a trained convolutional neural network. In some examples, the controller 140 is configured to combine classification and localization to detect a defect and localize the position of the defect in the image. In some examples, classification and localization may be performed together. The combination of classification and localization of defects in an image may be known as defect detection. The controller 140 may thus be configured to detect and localize a defect in an image by using a trained convolutional neural network.

In some examples, using the convolution neural network comprises image segmentation. Image segmentation techniques separate or divide an image into regions. The controller 140 may thus be configured to segment the image into image regions. Regions with potential defects may thus be separated from other regions of the image. The regions may be divided or segmented into pixels. An example of an image segmentation technique may be a region-based convolutional neural network (R-CNN). In a region-based convolutional neural network, the input may comprise the entire image and the output may comprise the pixels required for subsequent inspection and/or location. Another example of image segmentation techniques may be a region-based fully convolutional network (R-FCN).

Regions with potential defects may then be processed using classification and/or localization techniques. Accordingly, classification and/or localization techniques are focused on the regions with potential defects. Since no analysis of the entire image is required, data for detecting and/or determining a defect may be reduced without reducing the accuracy.

In some examples, the wind turbine blade inspection system 100 comprises a plurality of image-capturing devices 130. The plurality of image-capturing devices 130 may capture images of a set of inspection surfaces 200. In some examples, each image-capturing device 130 may capture an image of one inspection surface 200 of the set of inspection surfaces. In some examples, several image-capturing devices 130 may capture images from a single inspection surface. The set of inspection surfaces may extend in a chordwise direction 38 of the wind turbine blade 7. In some examples, the set of inspection surfaces may extend from a leading edge to a trailing edge. The inspection surfaces may thus be arranged side by side from the leading edge 53 to the trailing edge 54. Providing a plurality of the image-capturing device 130, may allow inspecting a surface of the wind turbine blade 7, e.g. a portion of an inner surface of the blade shell 73 extending in a chordwise direction 38, without moving the wind turbine blade inspection system 100.

In some examples, the wind turbine blade inspection system 100 comprises a plurality of directional light sources 110 and a plurality of diffuse light sources 120. The accuracy of the illumination may thus be further increased. This plurality of light sources may be employed to illuminate a set of inspection surfaces. In some examples, each directional light source 110 and each diffuse light source 120 are associated with one inspection surface 200. In other examples, a single inspection surface may be illuminated by several directional light sources 110 and/or several diffuse light sources 120.

In some examples, the wind turbine blade inspection system 100 comprises a support structure supporting the directional light source(s) 110, the diffuse light source(s) 120, and the image-capturing device(s) 130.

In some examples, the support structure may also support the controller 140. The controller 140 may thus be arranged at the same support structure. Wired connections may thus be used. The controller may thus be moved together with the support structure, and consequently, with the directional light source(s) 110, the diffuse light source(s) 120, and the image-capturing device(s) 130. In other examples, the controller may be mounted independently of the support structure. In these examples, the controller may be arranged in a fixed position (e.g. in an adjacent area within the manufacturing plant) and the support structure may be moved along the wind turbine blade.

In some examples, the wind turbine blade inspection system 100 comprises a conveying system to move the wind turbine blade inspection system 100 along a spanwise direction 37 of the wind turbine blade 7. For example, the wind turbine blade inspection system may be moved from the root portion 50 to a portion adjacent to the tip end 72. The wind turbine blade inspection system 100 may thus be moved on an inner side blade shell surface of a blade shell part, e.g. suction side blade shell part or pressure side blade shell part.

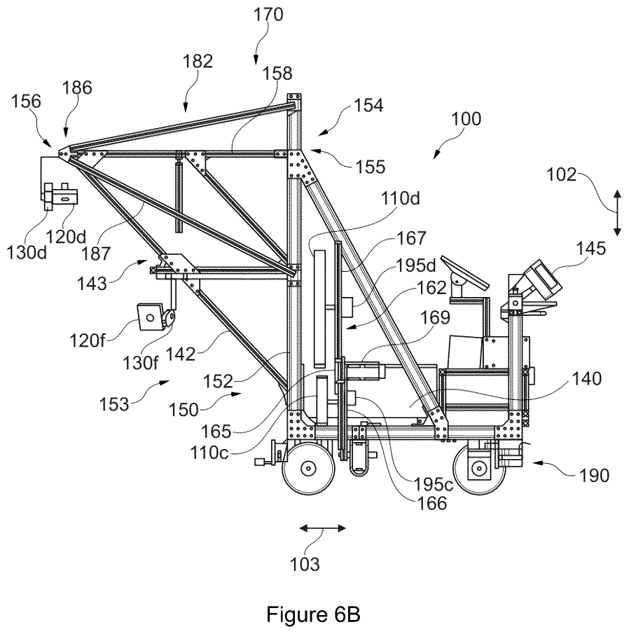

FIGS. 6a and 6b respectively illustrate a frontal view and a side view of a wind turbine blade inspection system 100 according to an example of the present disclosure. The wind turbine blade inspection system may be employed for detecting defects in an inner surface of a blade shell part. The inspection surface of the wind turbine blade may thus be located at the inner surface of the blade shell part. The wind turbine blade inspection system 100 of this example comprises a support structure 170 supporting a plurality of image-capturing devices 130, a plurality of directional light sources 110, and a plurality of diffuse light sources 120. The plurality of image-capturing devices 130, the plurality of directional light sources 110 and the diffuse light sources 120 are arranged along the transverse direction 101.

The wind turbine blade inspection system 100 further comprises a controller 140. The controller 140 may be configured to selectively activate one or more directional light sources of the plurality of directional light sources or one or more diffuse light sources of the plurality of diffuse light sources. Depending on the position of the wind turbine blade inspection system 100 relative to the length of the wind turbine blade, the controller 140 may be configured to select the diffuse light sources from the plurality of diffuse light sources and/or the directional light sources from the plurality of directional light sources to be activated.

The controller 140 may also be configured to receive a plurality of images from the plurality of image-capturing devices. In some examples, each pair of images (one obtained with directional light and the other one with diffused light) may be captured from a different inspection surface. In other examples, two or more image-capturing devices may capture a pair of images from a single inspection surface. In some examples, the controller 140 may instruct one or more image-capturing devices of the plurality of image-capturing devices to capture images from a set of inspection surfaces.

The plurality of directional light sources 110 and the plurality of image-capturing devices 130 may be arranged at different positions in the longitudinal direction 103. In this example, the plurality of directional light sources 110 is arranged behind the plurality of image-capturing devices 130 in the longitudinal direction 103. The plurality of directional light sources 110 may be configured to direct a directional light forward so as to illuminate inspection surfaces located below the plurality of image-capturing devices 130. The directional light may thus form an angle relative to the inspection surface to enhance the detection of some types of defects, e.g. wrinkles and/or steps.

In other examples, the plurality of directional light sources 110 may be arranged in front of the plurality of image-capturing devices 130. In these examples, the plurality of directional light sources 110 may direct the light backward so as to form an angle with the inspection surfaces.

In this example, the support structure 170 comprises a central frame 150 extending in a vertical direction 102 from a central frame lower portion 153 to a central frame upper portion 154. One or more columns may extend in the vertical direction 102. The central frame 150 of these figures comprises a first side column 151 and a second side column 152 arranged at opposite sides of the central frame 150. Transversal bars may connect the first side column 151 to the second side column 152.

The central frame upper portion 154 of these figures comprises a rear upper transversal bar 155 connecting the first side column 151 to the second side column 152. A first side upper longitudinal bar 157 and a second side upper longitudinal bar 158 respectively extend forward in a longitudinal direction 103 from the first side column 151 and from the second side column 152. A front upper transversal bar 156 connects the frontal ends of the first side upper longitudinal bar 157 and the second side upper longitudinal bar 158. The front upper transversal bar 156 is thus spaced a distance in the longitudinal direction 103 from the rear upper transversal bar 155.

In these figures, the central frame 150 comprises a first longitudinal strut bar and a second longitudinal strut bar 142 respectively extending from a lower portion of the first side column 151 and of the second side column 152 to the front upper transversal bar 156. The central frame 150 of these figures further comprises a front lower transversal bar 143 connecting a central portion of the first longitudinal strut bar to a central portion of the second longitudinal strut bar 142. The front lower transversal bar 143 may be arranged between the front upper transversal bar 156 and the rear upper transversal bar 155 along the longitudinal direction 103. The front upper transversal bar 156 is thus arranged forward than the front lower transversal bar 143.

In these figures, the support structure 170 comprises a first side wing 181 and a second side wing 182. The side wings 181 and 182 are connected at opposite sides of the central frame upper portion 154. The side wings 181 and 182 extend a length in the transversal direction 101. The side wings 181 and 182 of this example respectively comprise a first side transversal bar 183 and a second side transversal bar 186 extending in transversal directional 101. In FIGS. 5a and 5b, the first side transversal bar 183 is connected to the front upper transversal bar 156 and outwardly extends to a first side transversal bar end 185 in a transversal direction 101. Similarly, the second side transversal bar 186 is connected to the front upper transversal bar 156 and outwardly extends to a second side transversal bar end 188. In this example, the first side transversal bar 183 and the second side transversal bar 186 are spaced apart in the longitudinal direction 103 from the first side column 151 and the second side column 152.

A first side upper strut bar 184 may extend from the first side transversal bar end 185 to the first side column 151 in an inclined manner. Similarly, a second side upper strut bar 187 may be provided on the second side wing 182.

The support structure 170 of these figures support the plurality of image-capturing devices 130a, 130b, 130c, 130d, 130e and 130f. These image-capturing devices 130 are arranged in a transversal direction 101 of the wind turbine blade inspection system 100. These image-capturing devices 130 may thus acquire several images arranged in the transversal direction 101. The example of these figures comprises six image-capturing devices; however, other suitable numbers of image-capturing devices may also be possible.

In these figures, the image-capturing devices 130e and 130f are supported by the central frame lower portion 153. In particular, the image-capturing devices 130e and 130f are connected to the front lower transversal bar 143. The image-capturing devices 130e and 130f are arranged adjacent to the vertical axis of the wind turbine blade inspection system 100.

In these figures, the image-capturing devices 130b and 130c are arranged at the central frame upper portion 154, in particular at the front upper transversal bar 156. Furthermore, the image-capturing device 130a and 130d are respectively arranged at the first side transversal bar end 185 and at the second side transversal bar end 188. The image-capturing devices 130a, 130b and 130e substantially point at the first side and the image-capturing devices 130c, 130d and 130f substantially point at the second side. The image-capturing devices 130e and 130f are behind image-capturing devices 130a, 130b, 130c and 130d in the longitudinal direction 103. This offset in the longitudinal direction may increase the surface to be inspected.

A bracket may connect an image-capturing device 130 to the support structure 170. In some examples, the brackets fixedly connect the image-capturing devices 130 to the support structure 170. In other examples, the brackets rotatably connect the corresponding image-capturing devices 130 to the support structure. The image-capturing device may thus be oriented to a desired angle.

In some examples, the orientation of the image-capturing devices may be fixed for inspecting the entire inner surface of a blade shell part for a given wind turbine blade shape. In other examples, the orientation of the image-capturing devices may be adjusted depending on the position of the wind turbine blade inspection relative to the length of the wind turbine blade. For example, the orientation of the image-capturing devices 130a and 130d when the wind turbine blade inspection system 100 is at the root portion 50 may be different than when the wind turbine blade inspection system 100 is at a zone with the maximum chord. Orienting the image-capturing device 130 in function of the spanwise position of the wind turbine blade inspection system 100 may enhance the accuracy in obtaining images from the inspection surface. In some examples, the controller may adjust the orientation of the image-capturing devices. In addition, or alternatively, the orientation of the image-capturing devices may be manually performed.

In some examples, the first side wing 181 and/or the second side wing 182 may move relative to the central frame 150 in a vertical direction 102. In addition, or alternatively, the first side transversal bar 183 and/or the second side transversal bar 186 may be extendable. The position of some image-capturing devices may thus be adjusted to different wind turbine blade shapes. The controller 140 may be configured to move one or more image-capturing devices of the plurality of image-capturing devices by actuating the support structure 170, e.g. by moving the first side wing 181 and the second side wing 182 and/or by extending or retracting the first side transversal bar 183 and/or the second side transversal bar 186. Additionally, or alternatively, the image-capturing device may be manually positioned by moving the support structure 170.

The wind turbine blade inspection system 100 of these figures comprises a plurality of diffused light sources 120. In particular, the example of these figures comprises six diffused light sources 120a, 120b, 120c, 120d, 120e and 120f. However, in other examples, a different number of diffused light sources may be provided. The diffused light sources may be capable of diffusely illuminating the inspection surfaces to be captured by the plurality of the image-capturing devices 130.

The plurality of diffused light sources of these figures is arranged along the transversal direction 101. The diffused light sources 120a and 120d are respectively arranged at the first side transversal bar end 185 and at the second side transversal bar end 188. The diffused light sources 120b and 120c are arranged at the central frame upper portion 154, in particular, at the front upper transversal bar 156. The diffused light sources 120e and 120f of this example are arranged at the central frame lower portion 153, in particular, at the front lower transversal bar 143.

In this example, each diffuse light source 120 is associated with an image-capturing device 130. For example, the diffuse light source 120a is associated with the image-capturing device 130a. The diffuse light sources 120 of these figures are arranged adjacent or around the corresponding image-capturing device 130. Interferences and non-desired shadows may thus be avoided.

The diffuse light sources 120 may be connected to the support structure 170 through the bracket of the corresponding image-capturing device 130. For example, a single bracket may connect the diffuse light source 120d and the image-capturing device 130d to the second side wing 182. The diffuse light source(s) 120 may thus be oriented as explained regarding the image-capturing device(s) 130.

The support structure 170 of these figures comprises a first side articulated arm 161 and a second side articulated arm 162. Each of the articulated arms may support one or more directional light sources of the plurality of directional light sources. In FIGS. 5a and 5b, the first side articulated arm 161 and the second side articulated arm 162 are arranged at opposite sides of a central frame 150. The first side articulated arm 161 and the second side articulated arm 162 of these figures substantially extend in a transversal direction 101. In these figures, the articulated arms 161 and 162 are rotatably connected to the central frame 150.

In FIGS. 6a and 6b, the first side articulated arm 161 supports the directional light sources 110a and 110b, and the second side articulated arm 162 supports the directional light sources 110c and 110d. In these figures, each of these arms 161 and 162 is rotatably connected to the central frame lower portion 153, in particular, to a corresponding side of the central frame lower portion 153. The articulated arms 161 and 162 of this example are arranged behind the central frame 150.

In these figures, the first side articulated arm 161 comprises a first side inner bar 163 and a first side outer bar 164 connected to each other through a first side rotary joint 165. The first side outer bar 164 may thus rotate about the rotary joint 165 to form an angle relative to the first side inner bar 163. A first side actuator may move the first side outer bar 164 relative to the first side inner bar 163. In FIGS. 6a and 6b, the directional light source 110a is connected to the first side outer bar 164 and the directional light source 110b is connected to the first side inner bar 163. The position of the directional light sources 110a and 110b can thus be adjusted by moving the first side inner bar 163 and/or the first side outer bar 164.

Similar to the first side articulated arm 161, the second side articulated arm 162 of these figures comprises a second side inner bar 166 and a second side outer bar 167 connected through a second side rotary joint 168. In FIGS. 6a and 6b, the directional light source 110c is connected to the second side inner bar 166 and the directional light source 110d is connected to the second side outer bar 167. A second side actuator 169 may move the second side outer bar 167 with respect to the second side inner bar 166.

In some examples, the plurality of directional light sources may be rotatably connected to the corresponding bar 163, 164, 166 and 167. The directional light sources 110a, 110b, 110c and 110d may rotate about the longitudinal axis of the corresponding bar 163, 164, 166 and 167. The directional light may be adjusted in the spanwise direction 37 of the wind turbine blade 7. An angle between the directional light and the inspection surface may thus be adjusted. This may increase the capability of detecting some types of defects, e.g. wrinkles and/or steps. The plurality directional lights of these figures are arranged behind the plurality of image-capturing devices. The directional lights of FIGS. 6a and 6b are configured to direct the light forward in an inclined manner. For example, the axis of the light beam may form an angle with the inspection surface between 45° and 10°.

In some examples, the controller 140 may be configured to instruct a connection element to rotate a diffuse light source about the longitudinal axis of the corresponding bar. Additionally, or alternatively, this rotation may be manually performed.

As the plurality of directional light sources is connected to the articulated arms 161 and 162, the position of the directional light sources may be adjusted to a specific shape of the wind turbine blade shell part. In this example, the first side outer bar 164 and the second side outer bar 167 are extendable. An additional adjustment to the shape of the wind turbine blade shell part may thus be provided. A substantially fixed distance between the directional light sources and the inspection surface may thus be maintained. The accuracy of identifying defects may thus be increased in large wind turbine blades. For example, a distance between 20 cm and 60 cm may be maintained between the directional light sources and the inspection surfaces when an inner surface of a wind turbine blade shell part is inspected from the root portion to the tip end.

In some examples, the controller may control the position of the first articulated arm 161 and the second articulated arm 162. For example, the controller may actuate an actuator to move the first articulated arm 161 and the second articulated arm 162 relative to the central frame 150. Furthermore, the controller may control the rotation of the outer bars 164 and 167 relative to the inner bars 163 and 166. The first side actuator and the second side actuator 169 may move the outer bars 164 and 167 with respect to the inner bars 163 and 166. The first side actuator and/or the second side actuator 169 may comprise a hydraulic actuator. Alternatively, or additionally, an operator may move the bars into a specific position.

The wind turbine blade inspection system 100 of this example comprises a conveying system 190 to move or displace the wind turbine blade inspection system along a spanwise direction 37 of the wind turbine blade. The conveying system 190 of this example is connected to the central frame lower portion 153. In this example, the conveying system 190 comprises a plurality of wheels. These wheels may rotate over a surface of the blade shell 73 to displace the wind turbine blade inspection system 100 in a spanwise direction 37.

In other examples, the conveying system 190 may comprise one or more longitudinal guides extending along the length of the wind turbine blade. For example, one longitudinal guide may be adjacent to the trailing edge of the blade and another longitudinal guide may be adjacent to the leading edge. A driving mechanism may move the wind turbine blade inspection system over the longitudinal guides.

In some examples, the conveying system 190 comprises a powering system, e.g. an electric motor. The controller 140 may control the powering system to power the conveying system 190 so as to move the wind turbine blade inspection system 100. In other examples, the conveying system 190 may be driven by an operator.

In some examples, the conveying system 190 comprises a speed sensor to determine the speed of the wind turbine blade inspection system 100 when moving along the spanwise direction 37. The speed sensor may measure the rotations of the wheels. The controller may receive the speed and may control the conveying system to maintain the speed under certain speed limits. For example, the controller may control the operation of a powering system of the conveying system 190 so as to control the speed of the wind turbine blade inspection system 100.

In these figures, the central frame lower portion 153 comprises a platform to hold the controller 140. The controller 140 of this example may thus be moved with the support structure 170. In this example, the controller 140 is embedded in a computer. In other examples, the controller 140 may be, for example, a smartphone or a server. The wind turbine blade inspection system 100 of this example comprises a user interface device 145, e.g. a monitor. The controller 140 may output data about the detection and/or determination of a defect to a user interface device 145. The user interface device 145 may then show this data.

In some examples, the wind turbine blade inspection system 100 may comprise a positioning sensor to localize the wind turbine blade inspection system 100. For example, the positioning sensor may provide the position of the wind turbine blade inspection system 100 relative to the length of the wind turbine blade 7. The controller 140 may obtain, from the positioning sensor, the location of the wind turbine blade inspection system 100. Based on the location of the wind turbine blade inspection system 100, the controller 140 may also be configured to localize a defect if a defect is detected in the inspection surface 200.

In this example, the wind turbine blade inspection system 100 comprises a plurality of distance sensors 195a, 195b, 195c and 195d. These distance sensors may be used to determine a distance between the directional light sources and the inspection surfaces. In this example, each directional light source 110a, 110b, 110c and 110d is associated with a distance sensor 195a, 195b, 195c and 195d. In FIGS. 6a and 6b, the first side outer bar 164 supports the distance sensor 195a, the first side inner bar 165 supports the distance sensor 195b, the second side inner bar 166 supports the distance sensor 195c and the second side outer bar 167 supports the distance sensor 195d. Using these distance sensors may allow for increasing the consistency and repeatability of illuminating the wind turbine blade surface with the directional light source.

In this example, the distance sensors are LIDAR sensors. In other examples, ultrasonic sensors, capacitive, infrared sensors, or other types of proximity sensors may also be used.

In some examples, the controller 140 may obtain, from a distance sensor, a distance between the directional light source and the inspection surface. Based on this obtained distance, the controller 140 may instruct the corresponding articulated arm to position the directional light source at a predetermined distance, e.g. within certain limits. For example, the controller may be used to ensure that the light source is at a distance between 20 cm and 60 cm from the inner surface of a wind turbine blade shell part, e.g. suction side shell part or pressure side shell part.

In some examples, the wind turbine blade inspection system 100 may comprise inclination and/or proximity sensors. The inclination sensors may provide the inclination of the directional light sources and/or of the diffused light sources and/or of the image-capturing devices. The controller may receive data from these inclination sensors to modify its orientation. Proximity sensors may be used for detecting objects in the track of the wind turbine blade inspection system.

The inclination sensors may sense the inclination of the wind turbine blade inspection system 100 along both the longitudinal directional 103 and the transversal direction 101. Deviations from the expected inclination may then be detected by the controller 140. This deviation may subsequently be corrected, e.g. by actuating the articulated arms. The output of the inclination sensors may be employed to detect the position of the wind turbine blade inspection system along the spanwise direction of the wind turbine blade. Then, the configuration of the wind turbine blade inspection system may be adapted to the position along the spanwise direction.

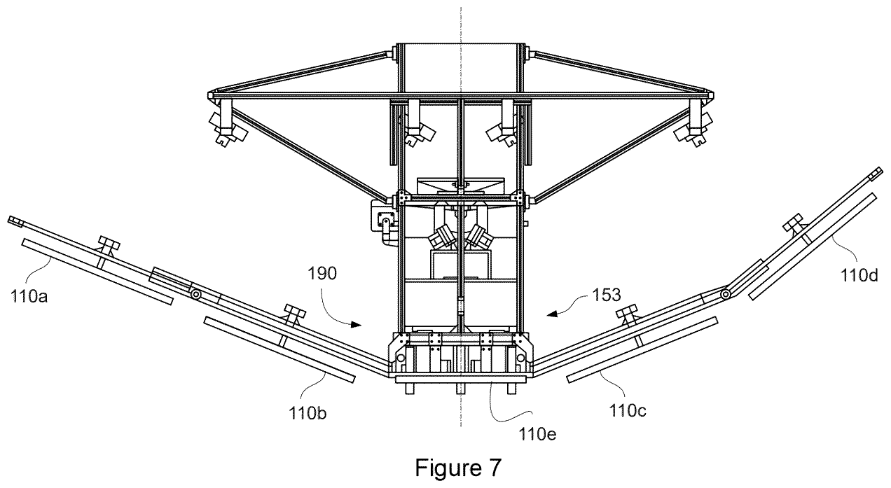

FIG. 7 schematically represents a wind turbine blade inspection system 100 according to an example of the present disclosure. The wind turbine blade inspection system 100 of this figure is similar to the wind turbine blade inspection system 100 depicted in FIGS. 6a and 6b. However, the plurality of directional light sources 110 further comprises a directional light source 110e. The directional light source 110e is arranged at the central frame lower portion 153. The directional light source 110e may thus illuminate inspection surfaces arranged in front of the moving system 190. The directional light source 110e may further improve the directional illumination of the inspection surfaces.

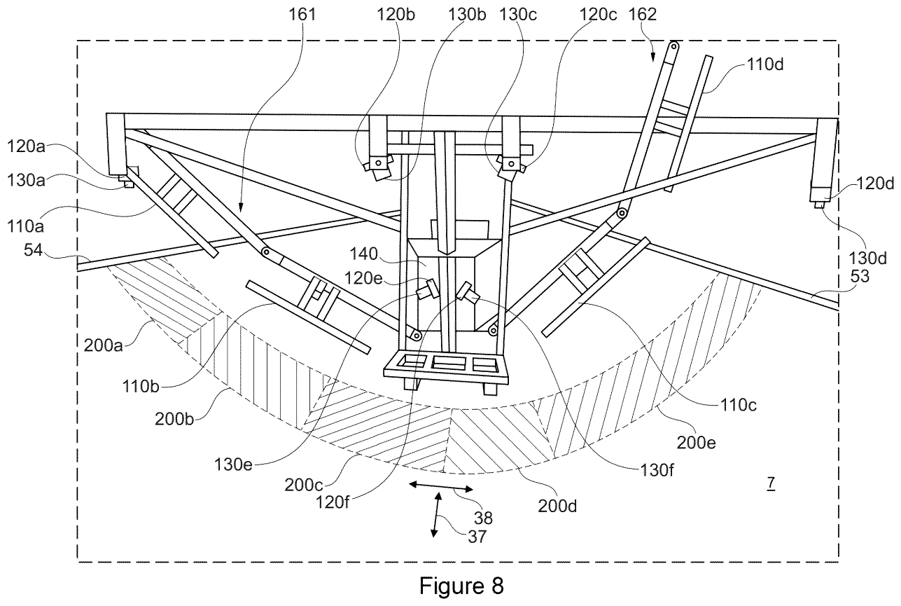

FIG. 8 schematically represents a wind turbine blade inspection system 100 according to an example of the present disclosure. In this figure, the wind turbine blade inspection system 100 is inspecting blade defects in an inner surface of a blade shell part. The blade shell part of this figure is a suction side shell part. In other examples, the blade shell part may be a pressure side shell part.

The wind turbine blade inspection system 100 may detect defects in a surface extending from the leading edge 53 to the trailing edge 54. The wind turbine blade inspection system 100 may inspect a set of inspection surfaces 200a, 200b, 200c, 200c, 200d and 200e. This set of inspection surfaces 200a, 200b, 200c, 200c, 200d and 200e extend from the leading edge 53 to the trailing edge 54 in a chordwise direction 38. The inspection surfaces are arranged next to each other to cover the surface extending from the leading edge 53 to the trailing edge 54. The inspection surfaces may comprise a surface between 4 m² and 0.5 m² .

The directional light sources 110a, 110b, 110c and 110d are mounted on the articulated arms 161 and 162. In this example, the directional light sources are substantially misaligned in the spanwise direction 37 relative to the set of inspection surfaces. The set of inspection surfaces is arranged downstream to the directional light sources. The directional light sources of this example may direct the directional light forward so that the axis of the light beam forms an acute angle with the corresponding inspection surface.

In this example, the directional light source 110a is configured to directionally illuminate the inspection surface 200a. The directional light source 110b may directionally illuminate the inspection surfaces 200b and 200c. The directional light source 110c may directionally illuminate the inspection surfaces 200d and 200e. In this example, due to the shape of the wind turbine blade shell part of this example, the directional light source 110d is not active.

The position of the directional light sources may thus be adjusted to the shape of the blade shell part. The inclination of the directional light sources may thus be adapted to the shape of the blade shell part. The directional light sources 110a, 110b and 110c may follow the inner contour of the blade shell part at this longitudinal position. The distance between the directional light sources and the inner surface of the blade shell part may also be adjusted within certain limits. This may improve the consistency of the inspection.

In this figure, each diffuse light source 120a, 120b, 120c, 120d, 120e and 120f is associated with an image-capturing device 130a, 130b, 130c, 130d, 130e, 130f. The diffuse light sources of these figures are arranged around the corresponding image-capturing device. This may uniformize the intensity of diffuse light received by the inspection devices and reflected by the image-capturing devices. The diffuse light sources and the image-capturing devices are substantially arranged above the set of inspection surfaces.

In this example, the image-capturing device 130a may capture images at least from the inspection surface 200a, the image-capturing device 130b at least from the inspection surface 200c, the image-capturing device 130e at least from the inspection surface 200b, the image-capturing device 130c at least from the inspection surface 200d and the image-capturing device 130f at least from the inspection surface 200d. In this example, the image-capturing device 130d is deactivated. The controller 140 may thus control the activation of the image-capturing devices.

In some examples, the images captured by the image-capturing devices are partially overlapped. For example, there may be at least a 25% overlap between the images. For example, the images captured by the imaging-capturing device 130b and by image-capturing device 130 c overlap at least 25%. These images may be processed to generate a chordwise view of the plurality of inspection surfaces. The

The distance between the image-capturing devices and the corresponding inspection surface may be within certain limits. For example, the distance may be between 0.3 meters and 3 meters.

The wind turbine blade inspection system 100 of this figure may be moved by the conveyor system 190 along the spanwise direction 37 of the wind turbine blade shell part. The wind turbine blade inspection system 100 may thus be positioned at different longitudinal positions of the blade shell part. The whole wind turbine blade shell part may thus be inspected with a single wind turbine blade inspection system 100.

In some examples, the wind turbine blade inspection system may be positioned at a first position along the spanwise direction 37. Then, one or more inspection surfaces may be illuminated by one or more directional light sources. The image-capturing devices may acquire images from the inspection surfaces when illuminated by the directional light sources. The directional light sources may then be deactivated and one or more diffused lights may be activated. The image-capturing devices may then capture images from the inspection surfaces when illuminated by diffused light sources. The controller may then analyze the images obtained from the image-capturing devices. In this example, the inspection surfaces are first illuminated by the directional light sources and then by the diffused light sources. However, in other examples, the inspection surfaces are first illuminated by the diffused light sources and then by the directional light sources.

Then, the wind turbine blade inspection system 100 may be moved to a second position to inspect a second set of inspection surfaces 200 extending along the chordwise direction 38 of the wind turbine blade shell part at this second position. The wind turbine blade inspection system 100 may then repeat moving the wind turbine blade inspection system to a forward position and to inspect a set of inspection surfaces 200 extending in the chordwise direction 38 at this forward position. The wind turbine blade inspection 100 may thus inspect the wind turbine blade shell part in a single pass. The wind turbine blade inspection system may be adjusted to the shape of the inner surface of the wind turbine blade shell part when moving along the spanwise direction 37. For example, the first side arm 161 and the second side arm 162 may adopt different configurations in function of the position along the spanwise direction 37, i.e. in function of the longitudinal position relative to the length of the wind turbine blade.

In some examples, the wind turbine blade inspection system 100 may be moved along the spanwise direction 37 of the wind turbine blade shell, e.g. from the blade root portion 50 to the blade tip end 72, and may acquire images at different positions when illuminated by directional light sources 110. A plurality of images when illuminated by directional light sources 110 may thus be acquired in a first pass. Then, the wind turbine blade inspection system 100 may be moved again along the spanwise direction 37 and may acquire images when illuminated by diffused light sources 120. A plurality of images when illuminated by diffused light sources 120 may be captured in a second pass. In other examples, images may be obtained when illuminated by diffused light sources 120 in a first pass and when illuminated by directional light sources 110 in a second pass.

In some examples, the wind turbine blade inspection system 100 may be moved along the spanwise direction at a substantially constant speed. The exposure time of the image-capturing devices and the illumination intensity of the light sources may be adjusted to minimize undesired movements of the light sources and the image-capturing devices while maintaining acceptable image quality. The speed may thus be determined taking into account the exposure time and the illumination intensity.

In some examples, the wind turbine blade inspection system 100 may inspect the wind turbine blade shell part from the blade root portion 50 to the blade tip end 37. In addition, or alternatively, the wind turbine blade inspection system 100 may inspect the wind turbine blade shell part from the blade tip end 37 to the blade root portion.

In some examples, the wind turbine blade inspection 100 may inspect a portion of the wind turbine blade shell part in one way and then inspect the portion of the wind turbine blade shell part in the opposite way. For example, the wind turbine blade inspection system may be moved from the blade root portion 50 to a middle portion of the blade, and then moved towards the blade root portion 50 in a reverse motion.

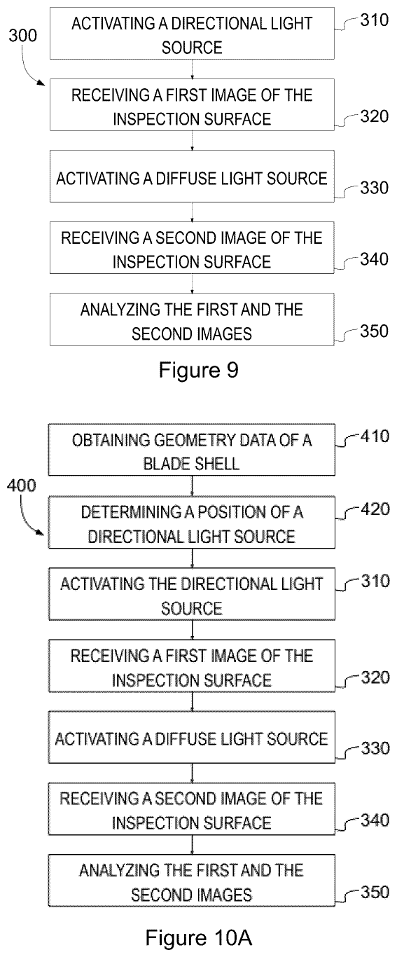

FIG. 9 is a block diagram of a computer-implemented method for detecting defects in a wind turbine blade according to an example of the present disclosure. A wind turbine blade inspection system 100 according to the examples herein may be used in the computer-implemented method 300. The method 300 may be employed for detecting blade defects in an inner surface of the blade shell part, e.g. a suction shell part or pressure shell part. The inner surface of the blade shell part may be inspected when the blade shell part is in the mold after being molded, e.g. through a resin infusion technology or a prepreg technology.

At block 310, activating a directional light source 110 of a wind turbine blade inspection system 100 to illuminate an inspection surface 200 of a wind turbine blade 7 is represented. A controller 140 may control the directional light source 110 to selectively turn on and off.

The method 300 further comprises receiving, by a controller 140, a first image of the inspection surface 200 illuminated by the directional light source, as represented at block 320. The method 300 may further comprise instructing an image-capturing device 130 to capture the first image of the inspection surface 200 when illuminated by the directional light source 110.

At block 330, activating a diffuse light source 120 of the wind turbine blade inspection system 100 to diffusely illuminate the inspection surface 200 is represented. The controller 140 may selectively activate and deactivate the diffuse light source 120.

At block 340, receiving, by a controller 140, a second image of the inspection surface 200 illuminated by the directional light source 110 is represented. In some examples, the controller 140 may instruct the image-capturing device 130 to capture the second image of the inspection surface 200 when illuminated by the diffuse light source 120.

In some examples, the controller 140 may activate the diffuse light source 120 after turning off the directional light source 110. In other examples, the controller 140 may first activate the diffuse light source 120 and receive the second image and, then activate the directional light source 110 to receive the first image.

The method 300 further comprises analyzing, by the controller 140, the first and the second images of the inspection surface 200 to detect a defect in the inspection surface 200, as represented at block 350.

The controller 140 may analyze the images according to any of the examples herein. For example, the method 300 may comprise analyzing the first and the second images of the inspection surface 200 using a convolutional neural network. The convolutional neural network may be according to any of the examples herein. For example, using convolutional neural network may comprise classification, localization, and/or segmentation of images.

In some examples, the convolutional neural network may be trained with the first and second images. These images may be used for training the convolutional neural network according to the examples herein.

The method 300 may comprise determining a type of defect if a defect is detected in the inspection surface 200. Determining a type of defect may be performed according to any of the examples herein. As explained before, comparing the first and the second images with reference images, and/or convolutional neural networks may be used to determine a type of defect.

In some examples, the method 300 further comprises determining a location of a defect if a defect is detected in the inspection surface 200. Positioning sensors may be used to determine a position of the wind turbine blade inspection system 100 along the spanwise direction 37 of the wind turbine blade. The controller may receive a position of the wind turbine blade inspection system 100 from the positioning sensor. Then, a position of the defect may be determined. Convolutional neural networks may also be used for localizing a defect.

Analysis of the images may also be used for determining the position of the defect. The controller may estimate a position of a defect by converting or correlating the pixels of the image into an estimation of the position of the defect in the blade shell. This correlation may also be used to determine the shape and/or the dimensions of the defect of the blade shell. The correlation may include converting pixels of the images to mm. In addition, from the CAD profile of the blade shell and the location of the image-capturing device with regard to the surface, these pixel-to-mm conversions can be pre-programmed for each image-capturing device and at every location of the blade shell.

Determining the position and/or shape and/or the dimensions of a defect position identified in the inspection surface may be used to assess the severity of this defect. Less severe defects may be allowable or be repaired. If repairing the defect is determined, the controller may output the defect dimensions and the defect position for subsequent repairing tasks. For example, the controller may generate a composed or stitched image of the blade shell part from the images captured with the capturing-image devices. These composed images may be compared with the geometrical model of the blade shell part. For example, these composed images may be overlayed on the CAD model of the blade shell part to generate an inspection report.

This may allow for mapping the defects on the surface of the blade shell part. For example, defect heat maps may be generated. This may improve the detection of defects in wind turbine blades. These heatmaps may be generated for different process parameters and/or for different wind turbine blade molds. These different heatmaps may then be compared to optimize process parameters to reduce defects.

In some examples, the wind turbine blade inspection system 100 comprises a plurality of directional light sources 110 and a plurality of diffuse light sources 120. These light sources 110 and 120 may be employed to illuminate a set of inspection surfaces 200. The set of inspection surfaces is arranged at a longitudinal position relative to the length of the wind turbine blade 7. The set of inspection surfaces may thus extend in a chordwise direction 38. The inspection surfaces of the set of inspection surfaces may extend edge to edge from the trailing edge to the leading edge in a chordwise direction.

The method 300 may comprise activating a plurality of directional light sources 110 of the wind turbine blade inspection system 7 to illuminate a corresponding inspection surface of the set of inspection surfaces. The method 300 may further comprise receiving, by the controller 140, a set of images of the set of inspection surfaces 200 illuminated by the plurality of directional light sources 110. In some examples, each of the inspection surfaces of the set of inspection surfaces is illuminated by a directional light source of the plurality of directional light sources 110. In other examples, one or more directional light sources of the plurality of directional light sources 110 may illuminate several inspection surfaces of the set of inspection surfaces 200.

The method 300 may comprise activating a plurality of diffuse light sources 120 of the wind turbine blade inspection system 100 to diffusely illuminate the corresponding inspection surface of the set of inspection surfaces 200 and receiving, by the controller 140, a set of second images of the set of inspection surfaces illuminated by the plurality of diffuse light sources 120. In some examples, each diffuse light source may illuminate one inspection surface of the set of inspection surfaces. In other examples, one diffuse light source can illuminate several inspection surfaces, or one inspection surface may be diffusely illuminated by several diffuse light sources.

A plurality of image-capturing devices 130 may be activated to acquire the first set of images and the second set of images. These images may then be analyzed by the controller 140 to detect a defect in the set of inspection surfaces 200.

In addition, the method 300 may comprise determining a position of the wind turbine blade inspection system 100. For example, a positioning sensor may be used to determine the longitudinal position of the wind turbine blade inspection system relative to the longitudinal length of the wind turbine blade or of the blade shell part. Based on this determined position, the method may further comprise instructing the wind turbine blade inspection system 100 to move the plurality of directional light sources 110 to a predetermined configuration. The position of the directional light sources 110 may thus be adapted to the shape of the blade shell part. The plurality of directional light sources 110 may comprise a different predetermined configuration based on the longitudinal position along the spanwise direction 37. For example, at a first position corresponding to 20% of the length of the wind turbine blade, the directional light sources 110 are arranged at a first predetermined configuration and at a second position corresponding to 60% of the length of the wind turbine blade, the directional light sources 110 are arranged at a second predetermined configuration.

In some examples, instructing the wind turbine blade inspection system 100 to move the plurality of directional light sources 110 may comprise actuating a first 161 and a second articulated arm 162. The first 161 and the second articulated arm 162 may be actuated according to any of the examples herein.

In some examples, the method 300 may receive geometry data about the dimensions and/or the shape of the blade shell parts to be inspected. This data may be the CAD geometry of the blade shell parts. The path of the movement of the wind turbine blade inspection system along the spanwise direction and the position of the directional light sources relative to the inner blade shell may be predefined prior to inspecting the blade shell part.

In some examples, the method may include obtaining the type or the model to be inspected. In some examples, the type of blade may be received from a user interface device. In some examples, the controller may receive dimensional data about the wind turbine blade, e.g. from an image-capturing device. This dimensional data may be compared with a dimensional database to determine the type of blade. Once the type of blades is obtained, the controller may obtain the configuration of the wind turbine blade inspection device. The controller may obtain the position of the image-capturing devices, e. g the height of the image-capturing devices from the inspection surfaces and/or the positions of the image-capturing devices in the transverse direction and/or in the longitudinal direction.

In some examples, the method may comprise generating composed images from the images received from the image-capturing devices. These composed images may represent a region of the blade shell part extending from the leading edge to the trailing edge. Partially overlapping the images acquired by the image-capturing devices may improve the generation of the composed images.

In some examples, the method comprises representing an identified defect on the composed image. This may comprise detecting the defect dimensions and the defect position according to any of the examples herein. The composed images with identified defects may be overlayed on the CAD model of the blade shell part. The method may further comprise generating data including the location and the type of defect. This data may include an inspection report.

In some examples, the method may comprise generating a defect heat map for different blade shell parts. These heatmaps may be generated for different process parameters and/or for different wind turbine blade molds. These different heatmaps may then be compared to optimize process parameters to reduce defects.

In some examples, the method 300 comprises repeating for a plurality of inspection surfaces 200 or a plurality of set of inspection surfaces 200 arranged at different longitudinal positions relative to the length of the wind turbine blade 7, activating the directional light source(s) 110, and receiving the first image of the inspection surface 200 or a set of first images of the set of inspection surfaces. The method 300 may further comprise repeating for the plurality of inspection surfaces 200 or the plurality of a set of inspection surfaces 200 arranged at different longitudinal positions relative to the length of the wind turbine blade 7, activating the diffuse light source(s) 120 and receiving the second image of the inspection surface 200 or a second set of images of the set of inspection surfaces. In addition, the method may comprise analyzing, by the controller 140, the first and the second images of the plurality of inspection surfaces 200 arranged at different longitudinal positions relative to the length of the wind turbine blade 7 to detect a defect in the plurality of inspection surfaces 200.

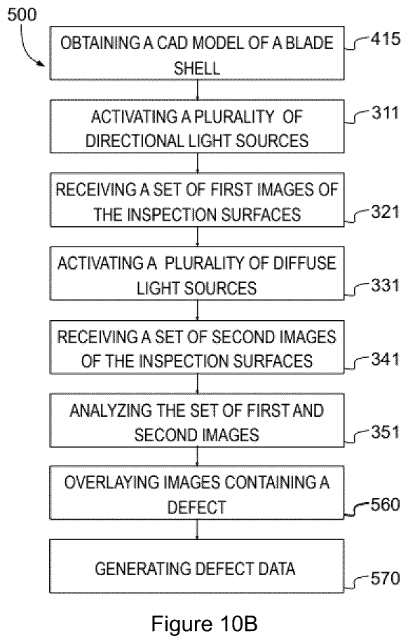

FIG. 10A is a block diagram of a computer-implemented method 400 for detecting defects in a wind turbine blade shell according to an example of the present disclosure. Blocks 310, 320, 330, 340 and 350 may according to any of the examples herein disclosed.

At block 410, obtaining geometry data of a blade shell part to be inspected is represented. Geometry data may comprise the dimensions and/or the shape of the blade shell parts to be inspected. This geometry data may include a CAD model of the blade shell part. The method may thus obtain the model or the type of the wind turbine blade to be inspected.

At block 420, determining, based on the geometry data, the position of the directional light source relative to an inner surface of the blade shell part to be inspected. The position of the directional light source or the plurality of directional light sources may be determined before inspecting the wind turbine blade shell part.

In some examples, the method 400 may further comprise determining, based on the geometry data, the path of the movement of the wind turbine blade inspection system along the spanwise direction of the blade shell part to be inspected. The path may thus be determined prior to inspect the wind turbine blade shell.

In some examples, the method 400 may further comprise actuating a first articulated arm and a second articulated arm comprising one or more directional light sources, based on the determined position of the directional light sources.

FIG. 10B is a block diagram of a computer-implemented method 500 for detecting defects in a wind turbine blade shell according to an example of the present disclosure.

At block 415, obtaining a CAD model of a blade shell part is represented. A CAD model may be an example of geometry data of a blade shell part.

A plurality of directional light sources of the wind turbine blade inspection to illuminate a corresponding inspection surface of a set of inspection surfaces of the wind turbine blade is represented at block 311. The set of inspection surfaces is arranged at a longitudinal position relative to the length of the wind turbine blade. The position of the plurality of directional light sources may be determined based on the CAD model of the blade shell part. The plurality of directional light sources may illuminate the inspection surfaces according to any of the examples herein.

The method 500 further comprises receiving, by the controller, a set of first images of the set of inspection surfaces illuminated by the plurality of directional light sources. The image-capturing devices may capture this set of first images according to any of the examples herein.

At block, 331, a plurality of diffuse light sources of the wind turbine blade inspection system to diffusely illuminate the corresponding inspection surface of the set of inspection surfaces is represented. The diffuse light sources may operate according to any of the examples herein.

The controller may receive a set of second images of the set of inspection surfaces illuminated by the plurality of diffuse light sources as represented at block 341.

At block 351, analyzing the set of first and second images is represented. The images may be analyzed according to any of the examples herein. The controller may detect a defect contained in the images.

At block 560, overlaying images received from the image-capturing devices containing a defect on the CAD model is represented. Images containing a defect may be compared to the CAD model to show the position of the defect within the blade shell part.

The method 500 further comprises generating defect data as represented at block 570. The generating defect data may comprise the location and the type of defect. In addition, the defect data may comprise the shape and/or the size of the defect.

In some examples, the method 500 may further comprise generating a mapping of the defects on the surface of the blade shell part. In some examples, the method 500 may further comprise generating, based on the defect data, a defect heatmap for different blade shell parts. These defect heatmaps may be used for comparing different blade shell parts. Manufacturing of the blade shell parts may thus be adjusted to reduce the amount and the severity of the defects.

In some examples, the method 500 may further comprise the steps described in FIG. 10A.

FIG. 10C is a block diagram of a computer-implemented method 600 for detecting defects in a wind turbine blade shell according to an example of the present disclosure. The method 600 comprises blocks 420, 310, 320, 330, 340 and 350 according to any of the examples herein.

At block 610, acquiring pixels from the first and the second images is represented. The pixels may be acquired according to any suitable method.

Based on the geometry of the blade shell part, the pixel may be converted to dimensions, e.g. to millimeters, as represented at block 620. Using this correlation, the shape of and/or the dimensions of a defect may be determined. Furthermore, the position of the defect may be determined. This conversion may be used for overlaying an image containing a defect onto the CAD model of the blade shell part.

The method 600 may further comprise any of the steps of any of the methods herein. For example, a plurality of directionally light sources may be used to illuminate several zones of the blade shell part.

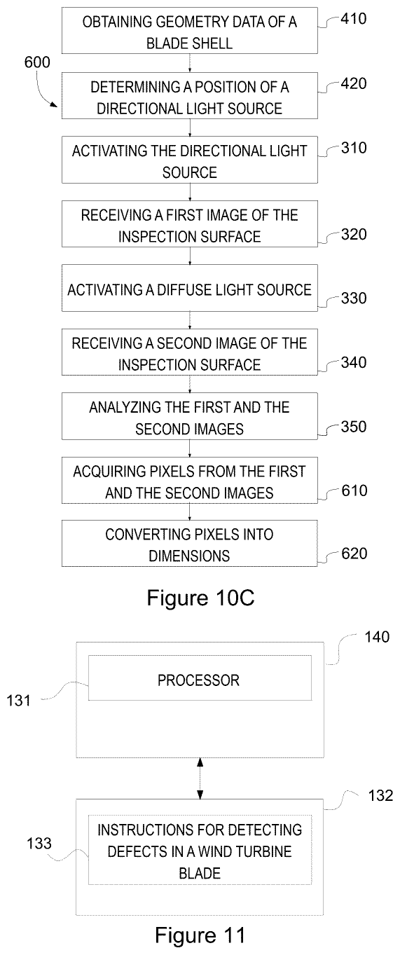

FIG. 11 represents a controller and a computing program according to an example of the present disclosure. The controller 140 or computing system comprises a processor 131 that performs operations on data, for example, for detecting a defect in a wind turbine blade. The processor 131 is configured to perform the method of detecting a defect in a wind turbine blade according to the examples herein. The processor 131 may execute a computing program 132 comprising instructions 133 that cause the processor 131 to detect a defect in a wind turbine blade according to the examples herein. The controller 140 may be a computer, a smartphone, a tablet, or a server.

In some examples, the processor 131 may be a dedicated processor for detecting wind turbine defects. In other examples, the processor 131 may also control other manufacturing operations.

The computer program 132 may be embodied on a storage medium (for example, a CD-ROM, a DVD, a USB drive, a computer memory or a read-only memory) or carried on a carrier signal (for example, on an electrical or optical carrier signal).

The computer program may be in the form of source code, object code, a code intermediate source and object code such as in partially compiled form, or in any other form suitable for use in implementing the methods of detecting a defect in a wind turbine blade according to the present disclosure. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

For reasons of completeness, various aspects of the present disclosure are set out in the following numbered clauses:

Clause 1: A wind turbine blade inspection system for detecting defects in a wind turbine blade, comprising:
a directional light source to directionally illuminate an inspection surface of a wind turbine blade;
a diffuse light source to diffusely illuminate the inspection surface of the wind turbine blade;
an image-capturing device to capture an image of the inspection surface;
a controller to:
   selectively activate the directional light source or the diffuse light source;
   receive from the image-capturing device an image of the inspection surface when illuminated by the directional light source and when illuminated by the diffuse light source; and
   analyze the received images of the inspection surface to detect a defect.

Clause 2: The wind turbine blade inspection system according to clause 1, wherein the controller is configured to selectively instruct the image-capturing device to capture the image of the inspection surface when illuminated by the directional light source and when illuminated by the diffuse light source.

Clause 3: The wind turbine blade inspection system according to any of clauses 1-2, wherein to analyze the images of the inspection surface comprises to use a convolutional neural network.

Clause 4: The wind turbine blade inspection system according to clause 3, wherein the controller is configured to train the convolutional neural network with the received images of the inspection surface.

Clause 5: The wind turbine blade inspection system according to any of clauses 1-4, wherein the controller is configured to determine a type of defect if a defect is detected in the inspection surface.

Clause 6: The wind turbine blade inspection system according to any of clauses 1-5, comprising a positioning sensor to determine a location of the wind turbine blade inspection system and wherein the controller is configured to:
obtain from the positioning sensor the location of the wind turbine blade inspection system; and
localize a defect if a defect is detected in the inspection surface.

Clause 7: The wind turbine blade inspection system according to any of clauses 1-6, comprising a conveying system to move the wind turbine blade inspection system along a spanwise direction of the wind turbine blade.

Clause 8: the wind turbine blade inspection system according to any of clauses 1-7, comprising:
a plurality of image-capturing devices to capture a set of inspection surfaces extending in a chordwise direction of the wind turbine blade;
a plurality of directional light sources; and
a plurality of diffuse light sources.

Clause 9: The wind turbine blade inspection system according to clause 8, comprising a support structure supporting the plurality of directional light sources, the plurality of diffuse light sources and the plurality of image-capturing devices, wherein the support structure comprises a first side and a second side articulated arms, wherein each of the articulated arms supports one or more directional light sources of the plurality of directional light sources.

Clause 10: The wind turbine blade inspection system according to any of clauses 1-9, wherein the controller is configured to:
obtain geometry data of a blade shell part to be inspected;
determine, based on the geometry data, the position of the directional light sources relative to the inner surface of the blade shell part to be inspected; and
optionally, determine, based on the geometry data, the path of the movement of the wind turbine blade inspection system along the spanwise direction of the blade shell part to be inspected.

Clause 11: The wind turbine blade inspection system according to any of clauses 1-10, wherein the controller is configured to:
obtain a model of the wind turbine blade to be inspected; and
determine the position of the directional light sources.

Clause 12: The wind turbine blade inspection system according to any of clauses 1-10, wherein the controller is configured to:
obtain a CAD model of the blade shell part;
overlay images received from the image-capturing devices containing a defect on the CAD file; and
generate data comprising the location and the type of defect.

Clause 13: A computer-implemented method for detecting defects in a wind turbine blade, comprising:
activating a directional light source of a wind turbine blade inspection system to directionally illuminate an inspection surface of a wind turbine blade;
receiving, by a controller, a first image of the inspection surface illuminated by the directional light source;
activating a diffuse light source of the wind turbine blade inspection system to diffusely illuminate the inspection surface;
receiving, by the controller, a second image of the inspection surface illuminated by the diffuse light source; and
analyzing, by the controller, the first and the second images of the inspection surface to detect a defect in the inspection surface.

Clause 14: The computer-implemented method of clause 13, comprising:
instructing an image-capturing device to capture an image of the inspection surface when illuminated by the directional light source; and
instructing the image-capture device to capture an image of the inspection surface when illuminated by the diffused light source.

Clause 15: The computer-implemented method according to any of clauses 13-14, wherein analyzing the first and the second images of the inspection surface comprises using a convolutional neural network. Clause 16: The computer-implemented method according to clause 15, comprising training the convolutional neural network with the first and second images.

Clause 17: The computer-implemented method according to any of clauses 13-16, comprising determining a type of defect if a defect is detected in the inspection surface.

Clause 18: The computer-implemented method according to any of clauses 13-17, comprising localizing of a defect if a defect is detected in the inspection surface.

Clause 19: the computer-implemented method according to any of clauses 13-18, comprising:
repeating for a plurality of inspection surfaces arranged at different longitudinal positions relative to the length of the wind turbine blade, activating the directional light source and receiving the first image of the inspection surface;
repeating for the plurality of inspection surfaces arranged at different longitudinal positions relative to the length of the wind turbine blade, activating the diffuse light source and receiving the second image of the inspection surface; and
analyzing, by the controller, the first and the second images of the plurality of inspection surfaces arranged at different longitudinal positions relative to the length of the wind turbine blade to detect a defect in the plurality of inspection surfaces.

Clause 20: The computer-implemented method according to any of clauses 13-19, comprising:
activating a plurality of directional light sources of the wind turbine blade inspection system to directionally illuminate a corresponding inspection surface of a set of inspection surfaces of the wind turbine blade, wherein the set of inspection surfaces is arranged at a longitudinal position relative to the length of the wind turbine blade;
receiving, by the controller, a set of first images of the set of inspection surfaces illuminated by the plurality of directional light sources;
activating a plurality of diffuse light sources of the wind turbine blade inspection system to diffusely illuminate the corresponding inspection surface of the set of inspection surfaces;
receiving, by the controller, a set of second images of the set of inspection surfaces illuminated by the plurality of diffuse light sources; and
analyzing, by the controller, the set of first and second images of the inspection surface to detect a defect in the set of inspection surfaces.

Clause 21: The computer-implemented method according to clause 20, comprising:
determining a position of the wind turbine blade inspection system; and
instructing, based on the determined position, the wind turbine blade inspection system to move the plurality of directional light sources to a predetermined configuration.

Clause 22: the computer-implemented method according to any of clauses 13-21, comprising:
obtaining geometry data of a blade shell part to be inspected;
determining, based on the geometry data, the position of the directional light source relative to an inner surface of the blade shell part to be inspected; and
optionally, determining, based on the geometry data, the path of the movement of the wind turbine blade inspection system along the spanwise direction of the blade shell part to be inspected.

Clause 23: The computer-implemented method according to clause 22, comprising actuating a first articulated arm and a second articulated arm comprising one or more directional light sources, based on the determined position of the directional light sources.

Clause 24: The computer-implemented method according to any of clauses 13-23, comprising:
obtaining a model of the wind turbine blade to be inspected; and
determining the position of the directional light sources.

Clause 25: The computer-implemented method according to any of clauses 13-24, comprising:
obtaining a CAD model of the blade shell part;
overlaying images received from the image-capturing devices containing a defect on the CAD model; and
generating defect data comprising the location and the type of defect.

Clause 26: The computer-implemented method according to clause 25, comprising:
generating, based on the generated defect data, a defect heatmap for different blade shell parts; and
comparing the defect heatmaps for different blade shell parts.

Clause 27: A controller comprising a processor configured to perform the method of any of clauses 13-26.

Clause 28: A computing program comprising instructions, which, when the program is executed by a processor, cause the processor to carry out the method of any of clauses 13-26.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1-15. (canceled)

16. A wind turbine blade inspection system for detecting defects in a wind turbine blade, comprising:
a directional light source configured to illuminate an inspection surface of a wind turbine blade at an acute angle relative to the inspection surface;
a diffuse light source configured to diffusely illuminate the inspection surface of the wind turbine blade;
an image-capturing device configured to capture an image of the inspection surface;
a controller in communication with the directional light source, the diffuse light source, and the image-capturing device, the controller configured to:
selectively activate the directional light source or the diffuse light source;
receive, from the image-capturing device, an image of the inspection surface when illuminated by the directional light source and when illuminated by the diffuse light source; and
analyze the received images of the inspection surface to detect a defect.

17. The wind turbine blade inspection system according to claim 16, wherein the controller comprises a convolutional neural network to analyze the images of the inspection surface.

18. The wind turbine blade inspection system according to claim 16, wherein the controller is configured to determine a type of the defect detected in the inspection surface.

19. The wind turbine blade inspection system according to claim 16, comprising a positioning sensor configured to determine a location of the wind turbine blade inspection system, wherein the controller is further configured to: obtain from the positioning sensor the location of the wind turbine blade inspection system; and localize the defect detected in the inspection surface.

20. The wind turbine blade inspection system according to claim 16, comprising a conveying system configured to move the wind turbine blade inspection system along a spanwise direction of the wind turbine blade.

21. The wind turbine blade inspection system according to claim 16, further comprising:
a plurality of the directional light sources;
a plurality of the diffuse light sources; and
a plurality of the image-capturing devices aligned in a chordwise direction of the wind turbine blade.

22. The wind turbine blade inspection system according to claim 21, further comprising;
a support structure, wherein the plurality of directional light sources, the plurality of diffuse light sources, and the plurality of image-capturing devices are configured on the support structure;
the support structure comprising a first side articulated arm and a second side articulated arms, wherein each of the articulated arms supports one or more of the directional light sources.

23. A computer-implemented method for detecting defects in a wind turbine blade, the method comprising:
activating a directional light source of a wind turbine blade inspection system to illuminate an inspection surface of the wind turbine blade, an axis of directional light source oriented at an acute angle relative to the inspection surface;
with a controller, receiving a first image of the inspection surface illuminated by the directional light source;
activating a diffuse light source of the wind turbine blade inspection system to diffusely illuminate the inspection surface;
with the controller receiving a second image of the inspection surface illuminated by the diffuse light source; and
with the controller, analyzing the first and the second images of the inspection surface to detect a defect in the inspection surface.

24. The computer-implemented method according to claim 23, wherein the controller analyzes the first and the second images of the inspection surface using a convolutional neural network.

25. The computer-implemented method according to claim 24, comprising training the convolutional neural network with the first and second images.

26. The computer-implemented method according to claim 23, further comprising repeating the method for each of a plurality of inspection surfaces arranged at different longitudinal positions relative to the length of the wind turbine blade.

27. The computer-implemented method according to claim 23, further comprising:
activating a plurality of the directional light sources of the wind turbine blade inspection system to illuminate a corresponding plurality of different inspection surfaces of the wind turbine blade;
with the controller, receiving a set of the first images of the plurality of inspection surfaces illuminated by the plurality of directional light sources;
activating a plurality of the diffuse light sources of the wind turbine blade inspection system to diffusely illuminate the corresponding plurality of different inspection surfaces of the wind turbine blade;
with the controller, receiving a set of the second images of the plurality of inspection surfaces illuminated by the plurality of diffuse light sources; and
with the controller, analyzing, the set of first images and the set of second images of the plurality of inspection surfaces to detect a defect in the set of inspection surfaces.

28. The computer-implemented method according to claim 27, further comprising:
determining a position of the wind turbine blade inspection system; and
instructing, based on the determined position, the wind turbine blade inspection system to move the plurality of directional light sources to a predetermined configuration to illuminate the plurality of different inspection surfaces.

29. A controller, comprising a processor configured to perform the method of claim 23.

30. A computing program, comprising instructions that, when executed by a processor, cause the processor to carry out the method of claim 23.
